(19) United States
(12) Patent Application Publication
(10) Pub. No.: US 2024/0190168 A1
(43) Pub. Date: Jun. 13, 2024

(54) VEHICLE COMPONENT WITH A MULTI-LAYER PAINT SYSTEM AND METHOD FOR PRODUCING SAME

(71) Applicants: Dr. Ing. h.c. F. Porsche Aktiengesellschaft, Stuttgart (DE); Otto Fuchs KG, Meinerzhagen (DE)

(72) Inventors: Gerd Burk, Wolfach (DE); Joachim Wullich, Emmendingen (DE); Simon Hinzmann, Meinerzhagen (DE); Isabella Furmanek, Luedenscheid (DE); Anton Rimmer, Meinerzhagen (DE); Skora Rafael, Meinerzhagen (DE)

(73) Assignees: Dr. Ing. h.c. F. Porsche Aktiengesellschaft, Stuttgart (DE); Otto Fuchs KG, Meinerzhagen (DE)

(21) Appl. No.: 18/530,499

(22) Filed: Dec. 6, 2023

(30) Foreign Application Priority Data
Dec. 8, 2022 (DE) 10 2022 132 722.1

(51) Int. Cl. B60B 7/00; B05D 3/12; B05D 5/06; B05D 7/14

(52) U.S. Cl. CPC B60B 7/004; B05D 3/12; B05D 5/068; B05D 7/14; B60B 2310/614; B60B 2310/656

(57) ABSTRACT

A vehicle component with a multi-layer paint system and a method for producing the same. The vehicle component has a multi-layer paint system applied to a base body of the vehicle component. The multi-layer paint system has at least a first color-giving coating layer and a second color-giving coating layer covering the first color-giving paint layer. The first color-giving coating layer and the second color-giving coating layer are separated from each other by a light-permeable intermediate coating layer. The second color-giving coating layer is removed in partial areas of the multi-layer paint system, such that the first color-giving coating layer is visible in these partial areas.

### CROSS-REFERENCE TO RELATED APPLICATION

This application claims priority to German Patent Application No. 10 2022 132 722.1, filed Dec. 8, 2022, the content of such application being incorporated by reference herein in its entirety.

### FIELD OF THE INVENTION

The invention relates to a vehicle component with a multi-layer paint system and to a method for producing same. The vehicle component is, in particular, a vehicle wheel or wheel rim that serves as a carrier for a tire.

### BACKGROUND OF THE INVENTION

Vehicle components, particularly vehicle wheels or rims, usually consist of a metal alloy, in particular an aluminum or magnesium alloy. To protect against corrosion and to improve the visual appearance of such vehicle components, the vehicle components are usually coated or provided with a paint system.

From WO 2011/060934 A1, which is incorporated by reference herein, is known practice, for imparting multicolored qualities to motor vehicle wheels, to apply a coating to a metallic base body, wherein the coating has at least two paint layers coated one atop another, of which at least one first paint layer is exposed in visible partial areas of the base body, by mechanical removal of a second paint layer covering the first paint layer in these partial areas.

Mechanical removal of the second paint layer can cause damage or partial removal of the first paint layer, which especially in the case of metal effect paints has a negative influence on their color effect. Even with high-precision tool guidance of the removal tool, damage to the first coating layer cannot be excluded or completely avoided, since on the one hand, the layer thicknesses of the coating layers are usually very low, typically 10 μm to 100 μm, and on the other hand, manufacturing-related variations in the layer thicknesses can occur. In addition, high-precision tool guidance is time-consuming.

### SUMMARY OF THE INVENTION

In view of the foregoing, a vehicle component according to aspects of the invention has a base body with a multi-layer paint system applied to the base body, wherein the multi-layer paint system has at least one first color-giving coating layer and a second color-giving coating layer covering the first color-giving coating layer, wherein the first color-giving coating layer and the second color-giving coating layer are separated from each other by a light-permeable intermediate coating layer, wherein in partial areas of the multi-layer paint system the second color-giving coating layer is removed, such that the first color-giving coating layer is visible in these partial areas.

By providing the intermediate coating layer, damage to the first color-giving coating layer is avoided when removing the second color-giving coating layer. For example, when lathing off the second color-giving coating layer by means of a lathe tool, contact between the lathe tool and the first color-giving coating layer is avoided. On the other hand, it is harmless for the lathe tool to come into contact with the intermediate coating layer and where appropriate to partially remove this intermediate coating layer. The intermediate coating layer thus serves as a buffer layer in order to avoid damage or removal of the first color-giving coating layer when removing the second color-giving coating layer. Since the intermediate coating layer is light-permeable, despite at least partial retention of the intermediate coating layer, it is ensured that the first color-giving coating layer is visible in the areas in which the second color-giving coating layer has been removed.

Preferably, the base body consists of a metal or a metal alloy, in particular of an aluminum alloy or a magnesium alloy.

Preferably, the base body is provided with a primer, wherein the multi-layer paint system is applied to the primer.

It is considered particularly advantageous if the vehicle component is a vehicle wheel or a wheel rim.

Preferably, the intermediate coating layer is transparent or at least translucent.

In a preferred embodiment, it is provided that the light-permeable intermediate coating layer is a clearcoat layer.

It is considered advantageous if the multi-layer paint system has an outermost coating layer, which completely covers all the underlying coating layers, wherein the outermost coating layer is light-permeable. This protects the underlying coating layers. Further, the outermost coating layer penetrates into the removed partial areas of the second color-giving coating layer during application and fills these areas. Further, the outermost coating layer also fills any removed areas of the intermediate coating layer.

It is considered particularly advantageous if the coating material used for the intermediate coating layer is identical to the coating material used for the outermost coating layer. As a result, these two coating layers have identical optical properties, which prevents light scattering or turbidity.

It is considered particularly advantageous if the intermediate coating layer has a layer thickness of 10 μm to 100 μm, preferably from 50 μm to 100 μm. These thickness ranges have proven advantageous with regard to the removal of the second color-giving coating layer without damaging the first color-giving coating layer, in particular when mechanical tools are used for the removal of the second color-giving coating layer.

It is considered particularly advantageous if the intermediate coating layer has a greater layer thickness than the outermost coating layer. It has emerged that the intermediate coating layer must usually have a greater layer thickness than is typically provided for a light-permeable coating layer, in order to fulfill its function, namely to serve as a buffer layer. From this point of view, it is also considered particularly advantageous if the intermediate coating has a greater layer thickness than the color-giving coating layers.

Preferably, the paint of the first coating layer is a metal effect paint, also called metallic paint. Especially with metal effect paints, there is a problem that damage to the surface of the metal effect paints can lead to an undesired change in the color effect of these paints. Therefore, the provision of an intermediate coating layer is particularly advantageous specifically when using metal effect paints as the first color-giving coating layer.

In principle, it is conceivable that the multi-layer paint system comprises one or more further color-giving coating layers in addition to the first and second color-giving coating layers, wherein the color-giving coating layers are respectively separated from each other by a corresponding light-permeable intermediate coating layer.

The method of the invention for producing a vehicle component with a multi-layer paint system applied to a base body of the vehicle component comprises at least the following method steps:
i. applying the multi-layer paint system to the base body, wherein the multi-layer paint system has at least a first color-giving coating layer and a second color-giving coating layer covering the first color-giving coating layer, wherein the first color-giving coating layer and the second color-giving coating layer are separated from each other by a light-permeable intermediate coating layer applied to the first color-giving coating layer,
ii. removing the second color-giving coating layer in partial areas of the multi-layer paint system, in such a way that the first color-giving coating layer becomes visible in these partial areas.

As already explained, the intermediate coating layer has the advantage that damage to the first color-giving coating layer is avoided when removing the second color-giving coating layer, since in the case of excessively deep removal, first the intermediate coating layer is removed and the first color-giving coating layer is not removed. As a result, it is not necessary to move the removal tool particularly precisely and, in addition, manufacturing tolerances in the coating layers are unproblematic, since if the second color-giving coating layer is removed too deeply, the intermediate coating layer is first removed and thus the first color-giving coating layer is protected.

It is considered particularly advantageous if the intermediate coating is at least partially removed when the second coating layer is being removed, as this facilitates and accelerates the manufacturing process. In addition, a particularly fast and residue-free removal of the second color-giving coating layer is made possible, since the tool can partially penetrate the intermediate coating layer.

It is considered particularly advantageous when the removal of the second color-giving coating layer is carried out mechanically, for example by means of a lathe tool. With regard to removal, it is also quite conceivable that the removal is carried out by means of a laser.

The advantageous configurations stated in connection with the vehicle component apply correspondingly to the method and vice versa.

### BRIEF DESCRIPTION OF THE DRAWINGS

In the following figures, the invention is explained in more detail by means of an exemplary embodiment, without being limited to this embodiment. Of these figures,

FIG. 1 shows a wheel rim with a multi-layer paint system,

FIG. 2 shows a lathe tool during removal of a coating layer,

FIG. 3 shows a schematic representation of the multi-layer paint system of the wheel rim in a state after the coating layers have been applied to a base body of the wheel rim,

FIG. 4 shows a schematic representation of the multi-layer paint system according to FIG. 3 in a state after a partial removal of the uppermost color-giving coating layer, and

FIG. 5 shows a schematic representation of the multi-layer paint system according to FIG. 3 in a state after the application of an outermost clearcoat layer.

### DETAILED DESCRIPTION OF THE INVENTION

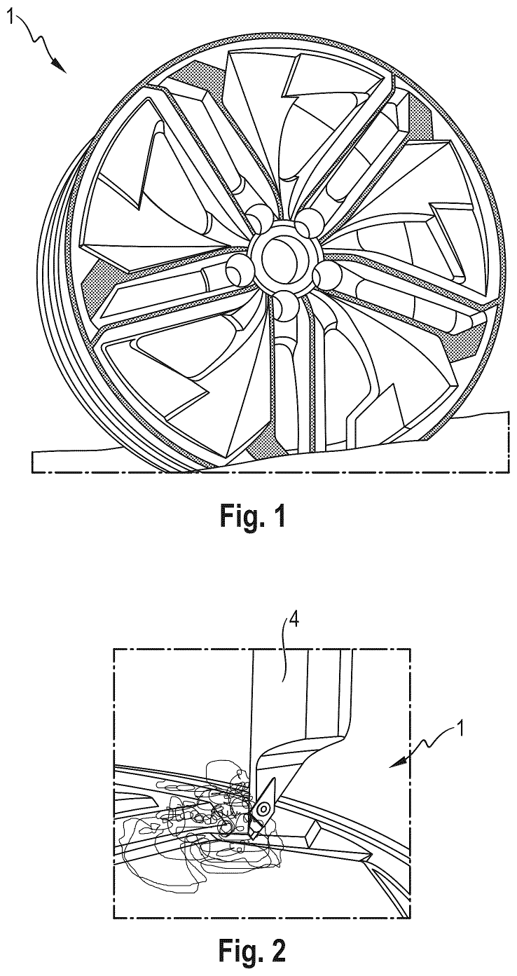

FIG. 1 shows a wheel rim 1 with a so-called dual-color appearance. This dual-color appearance is achieved by two color-giving coating layers 2, 3, which are coated one over the other, wherein a lower first color-giving coating layer 2 is partially covered by the upper second color-giving coating layer 3, so that only in partial areas in which the upper second color-giving coating layer 3 has been removed, the lower first color-giving coating layer 2 is visible. This creates areas of different colors for the viewer. The removal of the second color-giving coating layer 3 can, for example, be carried out mechanically by means of a lathe tool 4, as is represented exemplarily in FIG. 2.

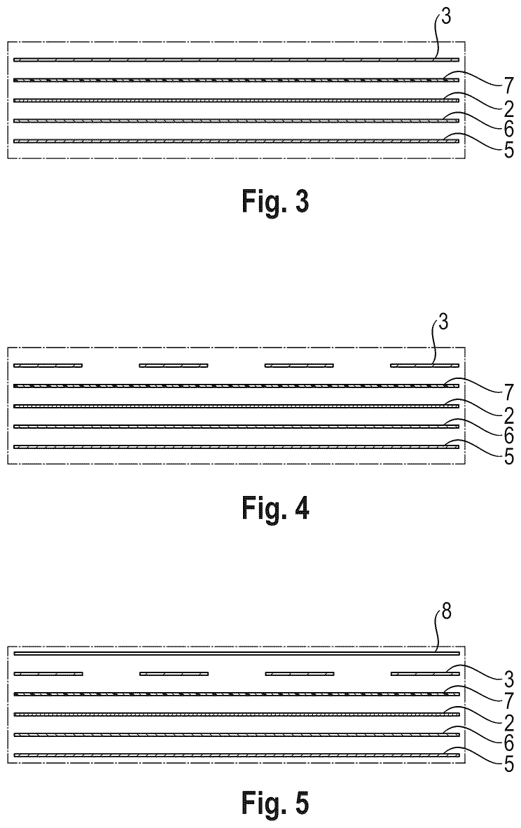

The structure of the multi-layer paint system is schematically represented in FIGS. 3 to 5. A primer 6 is first applied to a metallic base body 5 of the wheel rim 1. On this primer 6 then the first color-giving coating layer 2, on this first color-giving coating layer 2 a transparent intermediate coating layer 7, and on this intermediate coating layer 7 the second color-giving coating layer 3 is applied. This state is represented in FIG. 3. In the state represented in FIG. 3, the second color-giving coating layer 3 completely covers the first color-giving coating layer 2, so that the first color-giving coating layer 2 is not visible from the outside.

In order to make the first color-giving coating layer 2 visible from the outside, partial areas of the second color-giving coating layer 3 are removed by means of a cutting machining process, as is represented exemplarily in FIG. 2. In this case, the intermediate coating layer 7 serves as a buffer layer to prevent the lathe tool 4 from penetrating into the first color-giving coating layer 2.

The result after the partial removal of the second color-giving coating layer 3 is represented schematically in FIG. 4. In this state, the first color-giving coating layer 2 is visible from the outside in the areas in which the second color-giving coating layer 3 has been removed, despite the remaining intermediate coating layer 7, since the intermediate coating layer 7 is transparent.

After the removal or partial removal of the second color-giving coating layer 3, an outer transparent coating layer 8 is applied, which then covers the underlying coating layers 2, 3, 7 and also fills the gaps created by the partial removal of the second color-giving coating layer 3. This final state is represented in FIG. 5. The coating material of the outer transparent coating layer 8 and the coating material of the intermediate layer 7 may be a clearcoat.

What is claimed is:

1. A vehicle component comprising:
a base body; and
a multi-layer paint system applied to the base body,
wherein the multi-layer paint system has at least one first color-giving coating layer and a second color-giving coating layer covering the first color-giving coating layer,
wherein the first color-giving coating layer and the second color-giving coating layer are separated from each other by a light-permeable intermediate coating layer,
wherein the second color-giving coating layer is absent in partial regions of the multi-layer paint system such that the first color-giving coating layer is visible in the partial regions.

2. The vehicle component as claimed in claim 1, wherein the vehicle component is a vehicle wheel.

3. The vehicle component as claimed in claim 1, wherein the light-permeable intermediate coating layer is transparent or translucent.

4. The vehicle component as claimed in claim 1, wherein the light-permeable intermediate coating layer is a clearcoat layer.

5. The vehicle component as claimed in claim 1, wherein the multi-layer paint system has an outermost coating layer, which completely covers the color-giving coating layers and the intermediate coating layer, and wherein the outermost coating layer is light-permeable.

6. The vehicle component as claimed in claim 5, wherein the intermediate coating layer has a greater layer thickness than the outermost coating layer.

7. The vehicle component as claimed in claim 1, wherein paint of the first color-giving coating layer is a metal effect paint.

8. A vehicle comprising the vehicle component of claim 1.

9. A method for producing a vehicle component with a multi-layer paint system applied to a base body of the vehicle component, wherein the method comprises:
i. applying the multi-layer paint system to the base body, wherein the multi-layer paint system has at least a first color-giving coating layer and a second color-giving coating layer covering the first color-giving coating layer, wherein the first color-giving coating layer and the second color-giving coating layer are separated from each other by a light-permeable intermediate coating layer applied to the first color-giving coating layer; and
ii. removing the second color-giving coating layer in partial areas of the multi-layer coating in such a way that the first coloring coating layer becomes visible in the partial areas.

10. The method as claimed in claim 9, wherein the intermediate coating layer is at least partially removed when the second coating layer is being removed.

11. The method as claimed in claim 9, wherein the removal of the second coating layer is carried out mechanically.
